(19) United States
(12) Patent Application Publication
(10) Pub. No.: US 2022/0253919 A1
(43) Pub. Date: Aug. 11, 2022

(54) METHOD FOR GENERATING AN ELECTRONIC OFFER LIST

(71) Applicant: Marcus DENNER, Königstetten (AT)

(72) Inventor: Marcus DENNER, Königstetten (AT)

(21) Appl. No.: 17/667,569

(22) Filed: Feb. 9, 2022

(30) Foreign Application Priority Data
Feb. 9, 2021 (AT) A50078/2021

(51) Int. Cl. G06Q 30/06; G06Q 10/08

(52) U.S. Cl. CPC G06Q 30/0635; G06Q 10/0835

(57) ABSTRACT

The invention relates to a computer-implemented method for generating an electronic supply list (1) by a server computer (2) for transmission to a client computer (3, 3′, 3″), a computer-readable storage medium with instructions which cause a server computer (2) to perform such a method, and a device for carrying out such a method.

### RELATED APPLICATION

This application claims the benefit of priority of Austria Patent Application No. A50078/2021 filed on Feb. 9, 2021, the contents of which are incorporated by reference as if fully set forth herein in their entirety.

### FIELD AND BACKGROUND OF THE INVENTION

The invention relates to a computer-implemented method for generating an electronic offer list by a server computer for transmission to a client computer.

Methods for creating electronic offer lists or supply lists are known from the prior art, in particular for aggregating and providing offers from various suppliers, in particular delivery services, for example for the delivery of goods, groceries or food, but also for the pick-up of goods. Such methods are well-known in the B2C and B2B sectors (for example, for mail-order items or at restaurants), but are also increasingly common in the industrial sector. Areas of application include the delivery of spare parts from one of several warehouses for an industrial process, for example in the field of mechanical engineering, or the delivery of raw materials for the industrial production of goods on a factory site. In such methods, the first step is to enter a request for a product type, either for delivery or for pick-up, which is sent from a client computer (for example, a PC or smartphone) to a server computer. Typically, users authorized to submit requests are stored in a user database of the server computer, which usually also includes the user's location or address.

If a delivery of the requested product type is desired (delivery services), the server computer obtains the delivery area Lᵢ which is assigned to the user or his client computer, on the basis of the user data.

The delivery area can be a specific region, street, district, city, state, or even country; the number of delivery areas i=1, 2, . . . , N can be arbitrary.

The server computer then determines at least one supplier Aⱼ which is located in the delivery area Lⱼ and from which the user can subsequently order the desired product P. For this purpose, the server computer queries a previously created supplier database. Thus, the suppliers can be determined by specifying the delivery address. In the process, the delivery costs pⱼ of the supplier Aⱼ to the delivery area Lᵢ can also be queried, if necessary.

The number of suppliers j=1, 2, . . . , M stored with the server computer as participating suppliers is basically not limited; any number of suppliers Aⱼ may be provided in each delivery area.

Finally, the server computer compiles the identified suppliers Aⱼ, possibly limited to the relevant delivery area Lᵢ, into an electronic offer list and transmits it to the client computer. The user can then select the desired supplier from the offer list, for example on the basis of positive ratings of other customers, the price level, or the delivery costs. After transmitting the electronic offer list, the server computer accepts an order from a client computer and, in a further step, instructs the supplier Aⱼ selected by the user to deliver the desired product P to the relevant user by transmitting an electronic message to the associated supplier computer.

The customer therefore first decides on a supplier, and then selects a product and places an order. If pick-up is desired instead of delivery, the delivery area Lᵢ is not relevant, so that the server computer provides all suppliers Aⱼ in its database, regardless of their delivery area, unfiltered in the offer list.

However, such known methods suffer from the fact that often a large number of overlapping requests arrive at the server computer at the same time. That might have several reasons. For example, requests to delivery services might pile up at certain times; also, requests for spare parts in a ware house typically accumulate at the beginning of a shift.

On the one hand, this leads to a temporary technical overload of the supplier computers. On the other hand, the particular problem arises that on the side of the suppliers, the provision and delivery of the ordered goods cause considerable effort, for example in terms of the resources and means of delivery used. Consequently, during peak times, there are long delays in the provision and maybe also delivery of the goods. Furthermore, there is also the problem that orders cannot be controlled with conventional methods. It may be the case that a delivery is just on the way to fulfil an order in one delivery area, while a further order arrives for exactly the same delivery area. In this case, the supplier would have to initiate a second delivery.

These and other problems are solved according to the invention with a method and a device according to the independent claims.

### SUMMARY OF THE INVENTION

A method according to the invention is executed on the server computer and comprises several steps. First, an order time database, which can be updated, is provided on the server computer. When an order from a supplier Aⱼ is received, a time-limited order time slot Tⱼ is created in the order time database and subsequently held ready for further orders from that supplier. Over the duration of the order time slot Tⱼ, orders are collected and provided by the relevant supplier Aⱼ; at the end of the order time slot, the orders are delivered or made available for pick-up.

The order time slots Tⱼ are executed and stored as data objects implemented specifically for this purpose on the server computer. The order time database contains all active (open) order time slots Tⱼ of the suppliers Aⱼ. The order time database is empty at the beginning of the method and is filled by the server computer in the course of the method as soon as the first orders are received. The parameters of the order time slots, such as the time period Δt, the number of possible orders per order time slot Kⱼ and the number of possible goods per order can be defined by the suppliers Aⱼ.

The order time slots include at least a start time tₛₜₐᵣₜ and an end time t_{end} of an order period of the relevant supplier. The start time tₛₜₐᵣₜ is set with the first completed order on the server.

The end time t_{end} depends on the order period Δt specified by the respective supplier, for example 12, 15 or 20 minutes, i.e. t_{end}=tₛₜₐᵣₜ+order period. When selecting the length of the order period Δt, the respective supplier may, in particular, also take into account the typical provisioning time of the goods they offer.

By querying the order time database, the server computer checks whether an open order time slot Tⱼ already exists for the initially determined suppliers Aⱼ. The check can be done by checking whether at the current time t one of the order time slots Tⱼ is still open, i.e. whether the condition tₛₜₐᵣₜ≤t<t_{end} is valid.

If an order time slot Tⱼ is open at time t, this order time slot Tⱼ and the relevant supplier Aⱼ are included in the offer list. If no order time slot Tⱼ exists for one of the suppliers, this supplier will also be included in the offer list—an order time slot Tⱼ can be opened with the first order placed with this supplier. If no order time slot exists for a supplier and no order time slot can be created because this supplier is already fully booked or the order is placed outside the opening hours, no order can be placed with this supplier. In this case, the supplier does not appear in the offer list.

The invention may provide that those suppliers Aⱼ with open order time slots Tⱼ are ranked higher up in the offer list. The user is thus encouraged to add his order to an existing order which has already been received by a supplier Aⱼ.

The invention may further provide that in the offer list the suppliers Aⱼ are sorted depending on which order time slots Tⱼ end first. This means that the sorting is done in the order of ascending t_{end} of all currently open order time slots. Suppliers whose order time slots have an end time t_{end} closer to the current time t are therefore listed higher up in the list of offers than suppliers whose order time slots have an end time t_{end} further away from the current time t.

Suppliers for which there is not yet an open order time slot are ranked below all suppliers with open order time slots; for these suppliers, the first order can be placed by a user and thus an order time slot can be opened.

The electronic offer list is transmitted to the client computer, and the user can select a supplier, order the desired products P, and complete the order. In particular, this may lead to the user selecting that supplier whose order time slot ends first, in order to receive or pick up his order as soon as possible. However, the user can also choose that supplier whose order time slot closes last, in order to have enough time to select the desired goods.

On the suppliers' side, the order time slots are ranked in the offer list so that optimum use is made of each order time slot Tⱼ with as many orders as possible. The method also leads to technical advantages in delivery, since all orders placed within the order time slot Tⱼ can be transported together to specific delivery areas. However, suppliers whose order time slots Tⱼ are either already full due to the maximum number of possible orders per order time slot Kⱼ or already closed due to t>tₑnd do not receive any new orders, so that their servers are not overloaded.

The invention may provide that separate order time slots Tⱼ for the delivery of products and order time slots Tⱼ′ for the pick-up of products are provided by the server computer.

The invention may provide that the order time slots Tⱼ are each created for a time period Δt, wherein the time period Δt is supplier-specific and is determined by querying the supplier database.

The invention may provide that a maximum number Kⱼ of orders is provided for the order time slots Tⱼ and Tⱼ′, respectively, wherein the number Kⱼ is supplier-specific and is determined by querying the supplier database, and wherein the server computer checks whether the maximum number of orders in order time slots Tⱼ permits the booking of a new order.

The delivery or pick-up of the ordered products starts only when the order time slot closes. This means that orders can be collected within 20 minutes, for example. As soon as these 20 minutes have elapsed or the number of possible orders has been reached and all goods have been provisioned, the supplier begins with the delivery or provision for pick-up.

The invention may provide that, when the order is received from a client computer, the server computer informs individual or all client computers contained in the user database from the delivery area Lᵢ of the order by transmitting an electronic message and, if applicable, transmits to the client computers the order time slots Tⱼ existing in this delivery area Lᵢ. This informs the users in the relevant delivery area that an order has been placed by another user in their delivery area, so that they could participate in it.

According to the invention, it can be provided that the server computer, upon receipt of an order within a delivery area Lᵢ, defines a sub-delivery area SLᵢ assigned to the ordering client computer, informs any other client computers listed in the user database which are located in the sub-delivery area SLᵢ of the order by transmitting an electronic message, and transmits to these client computers any open order time slots Tⱼ for this sub-delivery area SLᵢ.

The invention may provide that the server computer receives from the client computer the position data of the client computer, in particular its GPS coordinates, for determining the delivery area Lᵢ and, if applicable, the sub-delivery area SLᵢ, then determines the corresponding location or address by querying an external address database, and determines the delivery area Lᵢ and, if applicable, the sub-delivery area SLᵢ by matching the address with delivery area addresses stored in advance in the delivery area database. In particular, this has the advantage that deliveries can be made to a mobile user's current location, and not just to the user's address stored in the user database. However, if no location release is made on the part of the client computer, the specified delivery address can still be used so that the method is not impaired.

The method according to the invention may be implemented as a computer program, in particular as a computer app. The app may comprise a server component as well as client components and supplier components. The client component may include modules for transmitting requests to the server, displaying the offer list, and ordering. The supplier component may include modules for providing the products and order time slots to the server and receiving the orders from the server. The client computers may in particular be configured as smartphones.

In particular, the supplier computers may be configured as smartphones, tablets, and/or desktop PCs. The server computer may also be configured as a desktop PC. Preferably, the computers may be connected via the internet.

The invention further comprises a computer-readable storage medium comprising instructions that cause a server computer to execute a method according to the invention.

The invention further comprises a device for generating an electronic offer list by a server computer for transmission to a client computer, comprising a server computer. The server computer is adapted to receive a request for suppliers of a product type from a client computer and to determine the delivery area by querying a user database or a delivery area database. The server computer is further adapted to determine at least one supplier Aⱼ by querying a supplier database, compile the determined suppliers Aⱼ in an electronic offer list, and transmit them to the client computer. Further, the server computer is adapted to receive an order for a product from the client computer and to forward it to the relevant supplier Aⱼ.

According to the invention, the server computer is adapted to provide an order time database that can be updated by the server computer, to check whether order time slots of the determined suppliers exist by querying the order time database, and, if applicable, to include the order time slots in the offer list.

If no order time slots exist for the relevant supplier, the server computer is adapted to create a new order time slot for that supplier as soon as a new order is placed. The server computer may further be adapted to sort the suppliers in the offer list in the order of the order time slots which end first.

The invention further relates to the use of a method and/or apparatus according to the invention for creating and sending electronic supply lists in a factory building with a plurality of physically distributed client computers and a plurality of physically distributed warehouses acting as suppliers of the required goods.

Further features according to the invention are apparent from the claims, the figures and the exemplary embodiments described below.

### BRIEF DESCRIPTION OF THE SEVERAL VIEWS OF THE DRAWINGS

FIG. 1a shows a schematic view of a first embodiment of a device according to the invention at the example of food deliveries. A server computer 2 is shown, which is connected to multiple client computers 3, 3′, 3″ and supplier computers 7, 7′, 7″, 7′″, 7″″ via a network, e.g. the internet. The client computers and the supplier computers are located in different delivery areas L₁, L₂, L₃, L₄, L₅.

FIG. 1b shows a schematic view of a second embodiment of a device according to the invention. In this exemplary embodiment, only order time slots for pick-ups Tⱼ′ are provided.

FIG. 1c shows a schematic view of a third embodiment of a device according to the invention. In this exemplary embodiment, both order time slots for deliveries Tⱼ and order time slots for pick-ups Tⱼ′ are provided independently of one another.

FIGS. 2a and 2b show a schematic representation of a further embodiment of a method according to the invention. In this embodiment, the delivery area 9 is divided into individual sub-delivery areas 10, 10′. The sub-delivery areas 10, 10′ can be individual communities, districts, but also blocks of houses, warehouses or work stations in a factory. Individual client computers are located in each sub-delivery area 10, 10′. For example, sub-delivery area 10 contains client computers CP₁, CP₂, CP₃, and CP₄; sub-delivery area 10′ contains client computers CP₅, CP₆, and CP₇.

FIG. 3 shows a schematic flowchart for creating ordered and unordered offer lists. In step S301, the client computer visits a website or opens an application. In step S302, the client computer specifies its shipping address. In step S303, the server computer checks whether a time slot with an order time window is open for the relevant sub-delivery area. If so, the server computer sends the client computer an ordered offer list (step S304) and the client computer sends its order to the server computer (step S305). If no order time slot is available in the sub-delivery area, then the server computer sends the client computer an unordered offer list (step S306). The client computer sends an order to the server computer (step S307), whereupon the server computer creates an ordered offer list for the sub-delivery area with new a time slot (step S308) and continues with step S304.

FIG. 4 shows a schematic flowchart for the creation of route data to the supplier computers after the time period Δt has elapsed, in order to enable efficient delivery of the ordered goods.

FIG. 5 shows a schematic flowchart for creating electronic messages to client computers in a sub-delivery area. In step S501, the server receives an order from a client computer. The server checks whether the client computer is within a sub-delivery area (step S502). If it is not, the server computer does not send a message (step S509) and the method ends. If the client computer is within a sub-delivery area, then the server computer checks whether electronic message sending has been approved for the client computers in that sub-delivery area (steps S503 and S504).

### DESCRIPTION OF SPECIFIC EMBODIMENTS OF THE INVENTION

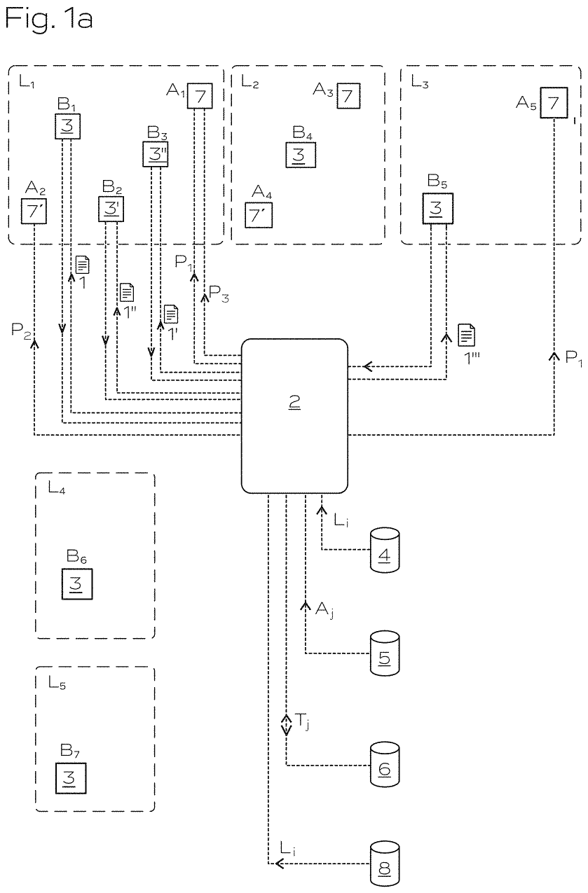

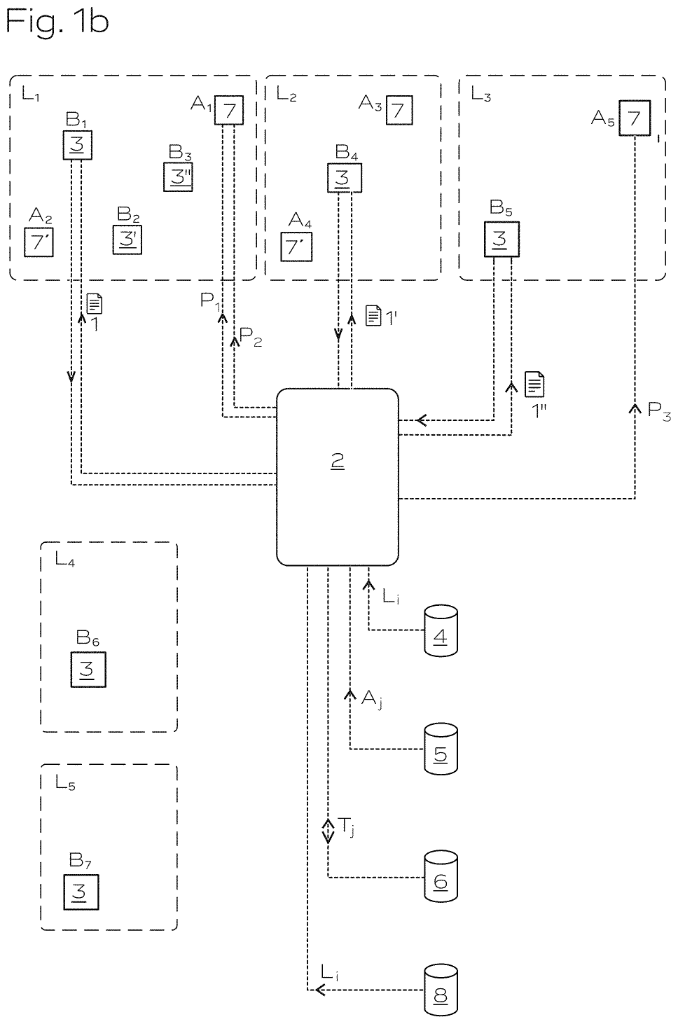

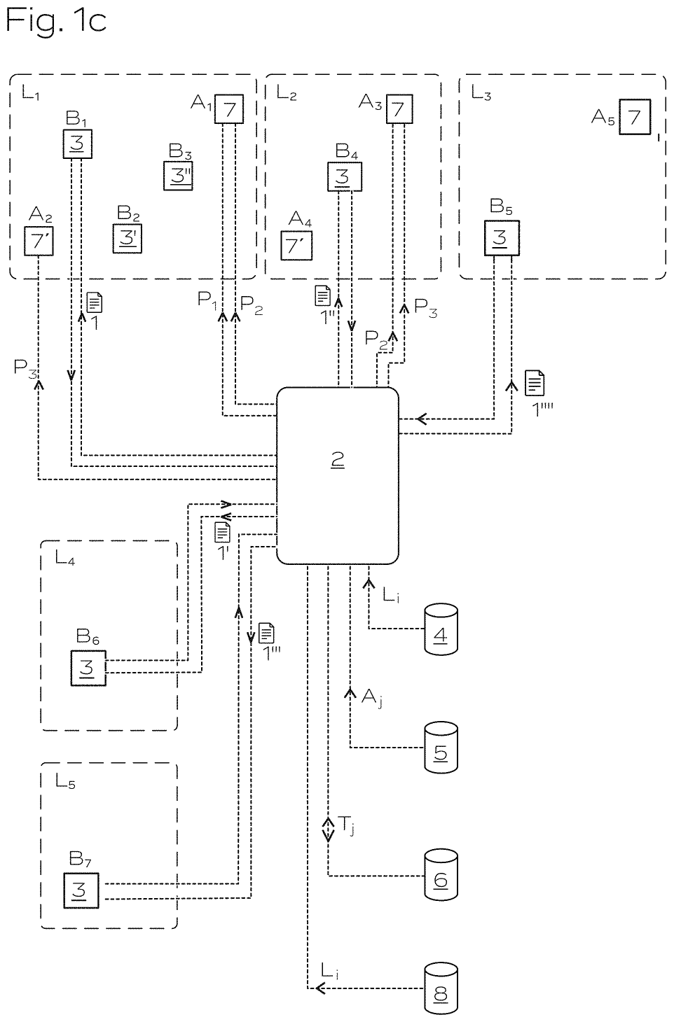

In the following, the invention will be explained in more detail by means of exemplary embodiments. FIGS. 1a to 1c show schematic views of embodiments of devices according to the invention.

FIG. 1a shows a schematic view of a first embodiment of a device according to the invention at the example of food deliveries. A server computer 2 is shown, which is connected to multiple client computers 3, 3′, 3″ and supplier computers 7, 7′, 7″, 7′″, 7″″ via a network, e.g. the internet. The client computers and the supplier computers are located in different delivery areas L₁, L₂, L₃, L₄, L₅.

On the server computer 2, a user database 4 is provided, which may have the following structure:

User database 4

| User | Delivery address | Delivery area |
|---|---|---|
| B₁ | Am Graben 5/1/60, 1010 Vienna | L₁ |
| B₂ | Schwedenplatz 5/13, 1010 Vienna | L₁ |
| B₃ | Gonzagagasse 1/1/12, 1010 Vienna | L₁ |
| B₄ | Heiligenstädter Straße 173, 1190 Vienna | L₂ |
| B₅ | Passauer Straße 15, 3433 Königstetten | L₃ |
| B₆ | Barichgasse 8/2/7, 1030 Vienna | L₄ |
| B₇ | Hartlgasse 14/1/5, 1200 Vienna | L₅ |
| . . . | . . . | . . . |

To this end, the client PCs or their users have registered in advance with an online service provided by the server computer 2 in order to be included in the user database 4. The delivery addresses entered are assigned by the server computer 2 to predefined delivery areas, which may be, for example, a district, a municipality or a city.

For this purpose, a delivery area database 8 is provided, which allows the respective addresses to be assigned to separate delivery areas. In the present example, users are assigned to five separate delivery areas L₁ to L₅ on the basis of their addresses.

A supplier database 5 is also provided on the server computer 2, which comprises supplier PCs with their delivery areas and the products offered. In this exemplary embodiment, the time period of the order time slots Δt and the maximum number of orders per order time slot Kⱼ are also stored in the database.

The supplier database can have the following structure, for example:

Supplier database 5

| Supplier | Products | Delivery area | Δt | Kⱼ |
|---|---|---|---|---|
| A₁ | P₁, P₂, P₃ | L₁ | 25 min | 5 |
| A₂ | P₂, P₃, P₄ | L₁ | 20 min | 5 |
| A₃ | P₁ | L₂ | 15 min | 7 |
| A₄ | P₃ | L₂ | 20 min | 4 |
| A₅ | P₁, P₄ | L₃ | 30 min | 4 |
| . . . | . . . | . . . | . . . | . . . |

The supplier PCs or product manufacturers/delivery services have registered in advance with an online service provided by the server computer 2 in order to be included in the supplier database 5. The products and delivery areas are made available to the server PC by the supplier PCs. The products may be individual products or categories of products, for example, Italian food, Chinese food, Austrian food, or the like. Individual products may be stored with prices in the supplier database.

The server computer 2 is adapted to receive a request for an order from a client computer 3, 3′, 3″ of a user, and to determine a delivery area Lᵢ associated with the client computer 3, 3′, 3″ or its user by querying the user database 4.

The server computer 2 is further adapted to determine, by querying the supplier database 5, suppliers Aⱼ for the delivery area Lᵢ in which the client computer 3, 3′, 3″ is located. The server computer compiles the determined suppliers Aⱼ of the product into an electronic offer list 1.

Further, the server computer 2 provides an order time database 6, which can be updated. The order time database 6 is adapted to store order time slots for each supplier and includes all order time slots Tⱼ open at the suppliers at the current time. The order time slots are defined by a start time tₛₜₐᵣₜ and an end time t_{end}. The time period Δt=t_{end}−tₛₜₐᵣₜ is predefined by the respective suppliers and is, for example, 20 minutes.

For providing the electronic offer lists 1 for delivery or pick-up, the server PC sorts the determined suppliers Aⱼ in the offer list in the order of the order time slots Tⱼ which end first. For example, a corresponding offer list 1 for delivery or pick-up looks as follows at time t=13:05:

| Supplier | Order time slot delivery Tⱼ |
|---|---|
| A₃ | 12:50-13:15 |
| A₁ | 13:00-13:30 |
| A₂ | — |

The offer list 1 for delivery is limited to those suppliers which deliver to the delivery area of the client PC from which the request originates. In contrast, the offer list 1 for pick-up includes all suppliers. Those suppliers whose order time slots end earlier are always ranked higher up in the offer list.

FIG. 1a illustrates a first exemplary embodiment of the steps of a method according to the invention in a device according to the invention, wherein only order time slots for deliveries Tⱼ are provided here. Due to the different delivery areas, the different users can only order deliveries from those suppliers in whose delivery area they are located.

For example, the order time database is empty at t=17:05, which means that no order time slot has been opened with any of the suppliers.

At 17:05, user B₁ makes a request to the server PC. The server PC provides an offer list 1 with those suppliers which can serve his delivery area, namely A₁ and A₂. In this exemplary embodiment, the sent offer list 1 has the following structure:

Offer list 1 for B₁ (t = 17:05)

| Supplier | Order time slot delivery |
|---|---|
| A₁ | — |
| A₂ | — |

The user orders the product P₂ from supplier A₂ and thus opens an order time slot with this supplier. The supplier has defined an order period of 20 minutes, so that for this order time slot tₛₜₐᵣₜ=17:05 and t_{end}=17:25 are set. The server computer 2 forwards the order for product P₂ to supplier A₂.

At 17:10, user B₃ makes a request to the server computer. At this time, an order slot is open for his delivery area, namely with supplier A₂ until 17:25. The server computer creates an offer list 1′, in which this supplier is ranked at the top:

Offer list 1′ for B₃ (t = 17:10)

| Supplier | Order time slot delivery |
|---|---|
| A₂ | 17:05-17:25 |
| A₁ | — |

User B₃ orders product P₁ from supplier A₁. Supplier A₁ has defined an order period of 25 minutes, so that tₛₜₐᵣₜ=17:10 and t_{end}=17:35. The server computer 2 forwards the order for P₁ to supplier A₁.

At 17:22, user B₂ makes a request to the server computer 2. At this time, order time slots with A₁ and A₂ are open.

The server computer 2 sorts the suppliers of offer list 1″ for B₂ in the order of the end times t_{end} of the order time slots, wherein order time slots Tⱼ ending earlier are ranked higher up:

Offer list 1″ for B₂ (t = 17:22)

| Supplier | Order time slot delivery |
|---|---|
| A₂ | 17:05-17:25 |
| A₁ | 17:10-17:35 |

The user places an order for product P₃ with supplier A₁, so that the order time slot with supplier A₁ now contains two orders—i.e. the second order is included in the existing order time slot. The server computer 2 ensures that the maximum number Kⱼ of orders per order time slot is not exceeded. The server computer 2 forwards the order for P₃ to supplier A₁.

At 17:45, user B₅ makes a request to the server computer. Only supplier A₅ serves the delivery area of this user so that offer list 1′″ for B₅ comprises this supplier only:

Offer list 1″′ for B₅ (t = 17:45)

| Supplier | Order time slot delivery |
|---|---|
| A₅ | — |

User B₅ orders product P₁ from supplier A₅ and thus opens order time slot Tⱼ with this supplier. Supplier A₅ has defined an order period of 30 minutes, so that for this order time slot tₛₜₐᵣₜ=17:45 and t_{end}=18:15. The server computer 2 forwards the order for P₁ to A₅. FIG. 1b shows a schematic view of a second embodiment of a device according to the invention. In this exemplary embodiment, only order time slots for pick-ups Tⱼ′ are provided.

The overall structure of the device and the content of the user database 4 and the supplier database 5 correspond to the exemplary embodiment according to FIG. 1a.

In this exemplary embodiment, each user can pick up his order from any supplier regardless of the delivery area. In the offer list, however, as in the exemplary embodiment of FIG. 1a, only suppliers in the delivery area of the respective user are displayed first, assuming that users prefer to make pick-ups from suppliers in their vicinity. The order in the offer list is again such that suppliers with an open order time slot Tⱼ′ are displayed first, followed by suppliers without an open order time slot. Among the open order time slots Tⱼ′, the ones ending earlier are ranked higher up.

For example, the order time database 6 is empty at time t=17:05, which means that no order time slot for pick-up Tⱼ′ was opened with any of the suppliers.

At 17:05, user B₁ makes a request to the server PC 2. The server PC sends back an offer list 1 with those suppliers which serve his delivery area, namely A₁ and A₂. The offer list 1 is unsorted, because no order time slot Tⱼ′ has been opened yet:

Offer list 1 for B₁ (t = 17:05)

| Supplier | Order time slot pick-up |
|---|---|
| A₁ | — |
| A₂ | — |

The user orders product P₁ from supplier A₁ and thus opens an order time slot for pick-up Tⱼ′ with this supplier. The supplier has defined an order period of 25 minutes, so that the values tₛₜₐᵣₜ=17:05 and t_{end}=17:30 are set for this order time slot.

At 17:10, user B₄ makes a request to the server computer 2.

User B₄ is shown suppliers A₃ and A₄ in the offer list for pick-up because the user's residence falls within the delivery area of these suppliers. However, user B₄ has a favorite restaurant—supplier A₁—for which he accepts a longer travel time for pick-up. Therefore, user B₄ searches specifically for supplier A₁ and is now shown this supplier, which actually falls into a different delivery area, for pick-up in a “pick-up” tab provided for this purpose:

Offer list 1′ for B₄ (t = 17:10)

| Supplier | Order time slot pick-up |
|---|---|
| A₁ | 17:05-17:30 |
| A₃ | — |
| A₄ | — |

The user places his order for product P₂ with supplier A₁ within the order time slot already opened by user B₁.

At this time, there are therefore two open orders in the order time slot for pick-up Tⱼ′ with supplier Δ₁. Again, the server computer 2 checks that the maximum number of orders Kⱼ is not exceeded.

At 17:45, user B₅ makes a request to the server computer. Due to his delivery address, this user is only shown supplier A₅ from delivery area L₃:

Offer list 1″ for B₅ (t = 17:45)

| Supplier | Order time slot pick-up |
|---|---|
| A₅ | — |

The user places his order for product P₃ with supplier A₅ and thus opens a new order time slot Tⱼ′ with this supplier. Supplier A₅ has defined an order period of 30 minutes, so that for this order time slot tₛₜₐᵣₜ=17:45 and t_{end}=18:15.

FIG. 1c shows a schematic view of a third embodiment of a device according to the invention. In this exemplary embodiment, both order time slots for deliveries Tⱼ and order time slots for pick-ups Tⱼ′ are provided independently of one another.

In this exemplary embodiment, the server computer 2 is adapted to query the order time database 6 to check whether order time slots Tⱼ of the determined suppliers Aⱼ already exist, either for delivery to the delivery area Lᵢ assigned to the user or for pick-up directly from the supplier. If order time slots Tⱼ or Tⱼ′ are open, the server computer 2 includes them in the offer list 1 and transmits them to the client computers 3. If an order time slot has not yet been created for a supplier in the order time database 6, the server PC 2 creates a new order time slot Tⱼ or Tⱼ′ as soon as an order for delivery or pick-up is received. Users are presented with the order time slots for delivery Tⱼ and the order time slots for pick-up Tⱼ′ in different screen windows or tabs.

For example, user B₁ sends a request for delivery at 17:05. Based on his address, suppliers A₁ and A₂ are displayed to him in offer list 1. The user places his order for product P₁ with supplier A₁ and thus opens an order time slot for delivery Tⱼ with this supplier. Supplier A₁ has defined an order period of 25 minutes, so that for the delivery order time slot with supplier A₁ tₛₜₐᵣₜ=17:05 and t_{end}=17:30. The server computer 2 forwards the order for P₁ to supplier A₁.

At the same time, user B₆ sends a request for delivery. Since no suppliers are found in the supplier database for his delivery area, the user is only given the option of pick-up; the offer list 1′ is empty. He selects supplier A₃ himself (for example, using a search function) and places an order for product P₂ with supplier A₃ for pick-up. The server computer 2 opens an order time slot for pick-up with A₃.

This supplier has defined an order period of 15 minutes, so that the order time slot for pick-up with tₛₜₐᵣₜ=17:05 and t_{end}=17:20 is generated. Thus, the order time database 6 now has an order time slot for delivery Tⱼ with A₁ and an order time slot for pick-up Tⱼ′ with A₃. The server computer 2 forwards the order for P₂ to supplier A₃.

At 17:10, user B₄ sends a request to the server PC. Based on his delivery area, suppliers A₃ and A₄ are eligible for delivery. The server PC transmits the following offer list 1″ for delivery Tⱼ or pick-up Tⱼ′:

Offer list 1″ for B₄ (t = 17:10)

| Supplier | Order time slot delivery Tⱼ | Order time slot pick-up Tⱼ′ |
|---|---|---|
| A₃ | | 17:05-17:20 |
| A₄ | | |

User B₄ decides on a delivery from supplier A₃ and places his order for product P₃, so that an order time slot for delivery Tⱼ is created with supplier A₃. A₃ has defined an order period of 15 minutes, so that the order time slot for delivery with A₂ is from 17:10 to 17:25. The server computer 2 forwards the order for P₃ to supplier A₃.

At 17:24, user B₇ sends a request to the server PC. Based on his delivery area, neither delivery nor pick-up is suggested to him; his offer list 1′″ is empty. However, the user searches specifically for supplier A₁ and places an order there for pick-up of product P₂. Supplier A₁ has defined an order period of 25 minutes, so that the order time slot for delivery Tⱼ′ of supplier A₁ is tₛₜₐᵣₜ=17:24 and t_{end}=17:49. The server computer 2 forwards the order for P₂ to supplier A₁.

At 17:40, user B₅ sends a request to the server computer 2. On the basis of the delivery area, only supplier A₅ would be suggested to the user. However, user B₅ specifically searches for product P₃ of supplier A₂ from delivery area Lᵢ and receives the following offer list 1″″:

Offer list 1″″ for B₅ (t = 17:40)

| | | |
|---|---|---|
| Supplier | Order time slot delivery Tⱼ | Order time slot pick-up Tⱼ′ |

A₂
A₅

Supplier A₂ has defined an order period of 20 minutes, so that an order time slot for pick-up Tⱼ′ with tₛₜₐᵣₜ=17:40 and t_{end}=18:00 is generated. The server computer 2 forwards the order for product P₃ to supplier A₂.

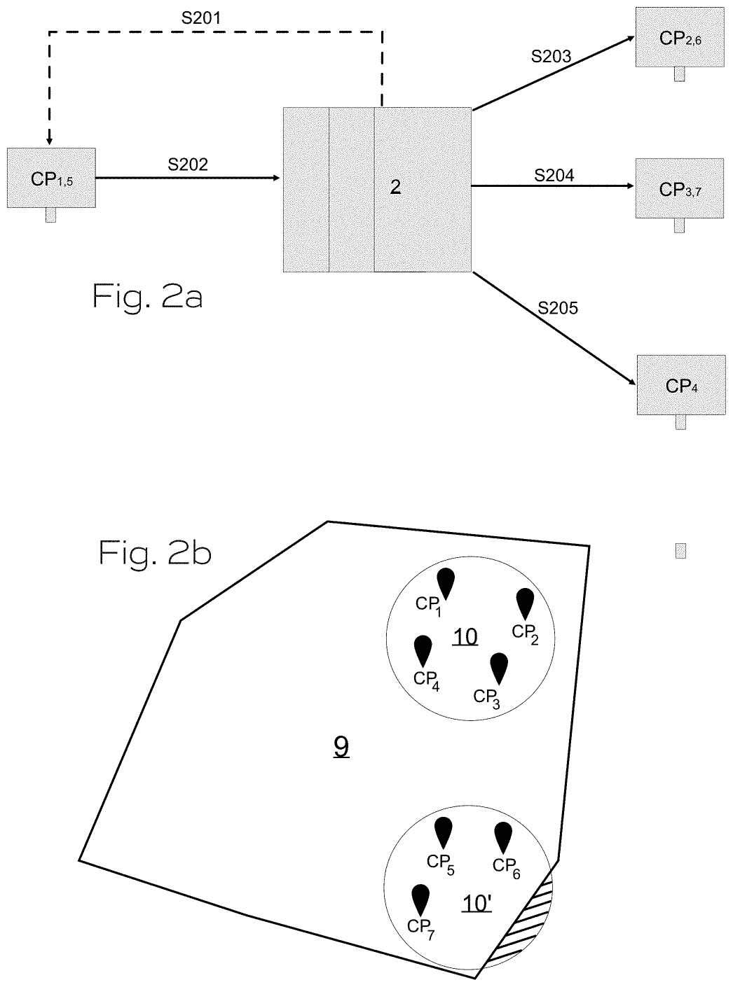

FIGS. 2a and 2b show a schematic representation of a further embodiment of a method according to the invention. In this embodiment, the delivery area 9 is divided into individual sub-delivery areas 10, 10′. The sub-delivery areas 10, 10′ can be individual communities, districts, but also blocks of houses, warehouses or work stations in a factory. Individual client computers are located in each sub-delivery area 10, 10′. For example, sub-delivery area 10 contains client computers CP₁, CP₂, CP₃, and CP₄; sub-delivery area 10′ contains client computers CP₆, CP₆, and CP₇.

In the first step, client computer CP₁ orders goods for delivery from server computer 2. Server 2 checks whether the delivery address of CP₁ falls within delivery area 9 of the supplier computers stored on the server. This matching is done via an interface with a geo-information system, e.g. Google Maps, and using the delivery area database 8. If the server detects an overrun of the delivery area, this part is not added to the sub-delivery area and is not available (shaded area).

In the second step, the server 2 checks whether an order time window has already been opened in a predetermined radius around the delivery address of the client computer CP₁. If no order time window has been opened yet, an unordered offer list 1 is first transmitted to the client computer CP₁ (step S201). The radius is predefined in the delivery area database 8.

Once CP₁ successfully places its order, CP₁'s data is transmitted to the server computer 2 using PHP files containing an HTML structure (step S202).

As soon as the server computer 2 receives and processes the request, all client computers located within the delivery radius generated by CP₁ are provided with ordered offer lists that include the order time window initiated by CP₁ in the first place (steps S203-S205).

Thus, a temporary sub-delivery area 10 is automatically created by the server within the delivery area 9 by the initial order of CP₁. From the time of the order by CP₁, the server creates an order time window with a predefined duration Δt=TS₁. Within TS₁, users located within the delivery radius of sub-delivery area 10 can join. For example, an order from client computer CP₁ at 13:00 defines a time duration of 10 min, and further orders from CP₂, CP₃, and CP₄ are accepted at 13:02, 13:05, and 13:09.

Client computer CP₆, which is outside sub-delivery area 10 but within delivery area 9, can also trigger the process for by placing an initial order and create its own sub-delivery area 10′. This is then available to the neighboring client computers CP₆ and CP₇. The sub-delivery area is automatically closed by the server computer 2 after a predetermined time has elapsed.

For example, an order from client computer CP₆ at 13:02 defines a time period of TS₁=10 min, and further orders from CP₆ and CP₇ are accepted at 13:08, 13:10. With the creation of each new order time window for a specific sub-delivery area 10, 10′, all client PCs in this temporary sub-delivery area 10, 10′ are automatically notified by means of an electronic message (such as instant messaging, provided they have given their approval for this). In doing so, the server determines the corresponding default settings on the individual terminals, checks the address data within the relevant radius and checks whether several messages have already been sent to identical terminals within a certain period in the area.

The orders are automatically forwarded by the server computer 2 to the supplier computers, and the data relevant for delivery is transmitted. Then, based on the order data and the real-time traffic data, the server computer 2 determines a route to deliver the ordered goods to the users efficiently and quickly.

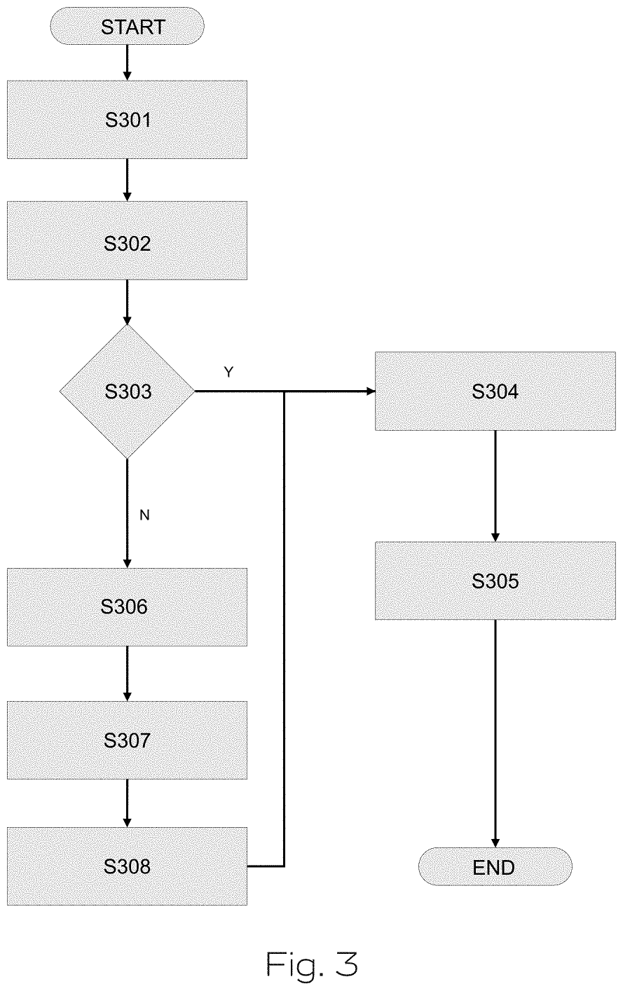

FIG. 3 shows a schematic flowchart for creating ordered and unordered offer lists. In step S301, the client computer visits a website or opens an application. In step S302, the client computer specifies its shipping address. In step S303, the server computer checks whether a time slot with an order time window is open for the relevant sub-delivery area. If so, the server computer sends the client computer an ordered offer list (step S304) and the client computer sends its order to the server computer (step S305). If no order time slot is available in the sub-delivery area, then the server computer sends the client computer an unordered offer list (step S306). The client computer sends an order to the server computer (step S307), whereupon the server computer creates an ordered offer list for the sub-delivery area with new a time slot (step S308) and continues with step S304.

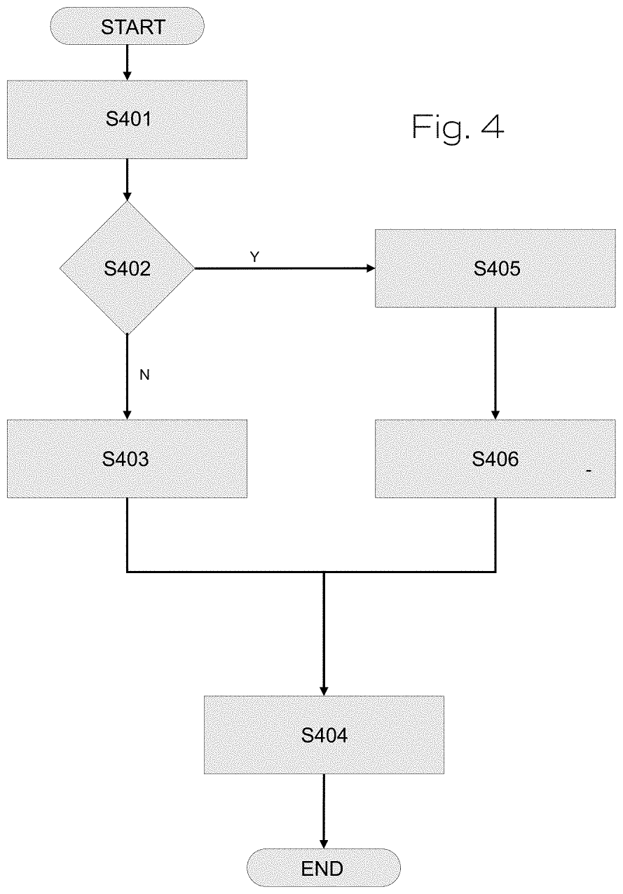

FIG. 4 shows a schematic flowchart for the creation of route data to the supplier computers after the time period Δt has elapsed, in order to enable efficient delivery of the ordered goods.

In step S401, the server computer transmits all orders to the supplier computers. In step S402, the server computer checks whether orders to multiple client computers are included. If not, the server computer determines the address of the single client computer by querying a geographic information system (step 403), creates route data, and transmits the route data to the relevant supplier computer (step S404). If the time slot includes multiple client computers, then the server computer determines the address of the relevant client computers (step S405) and creates a route plan based on order data and traffic data (step S406). The method continues with step S404.

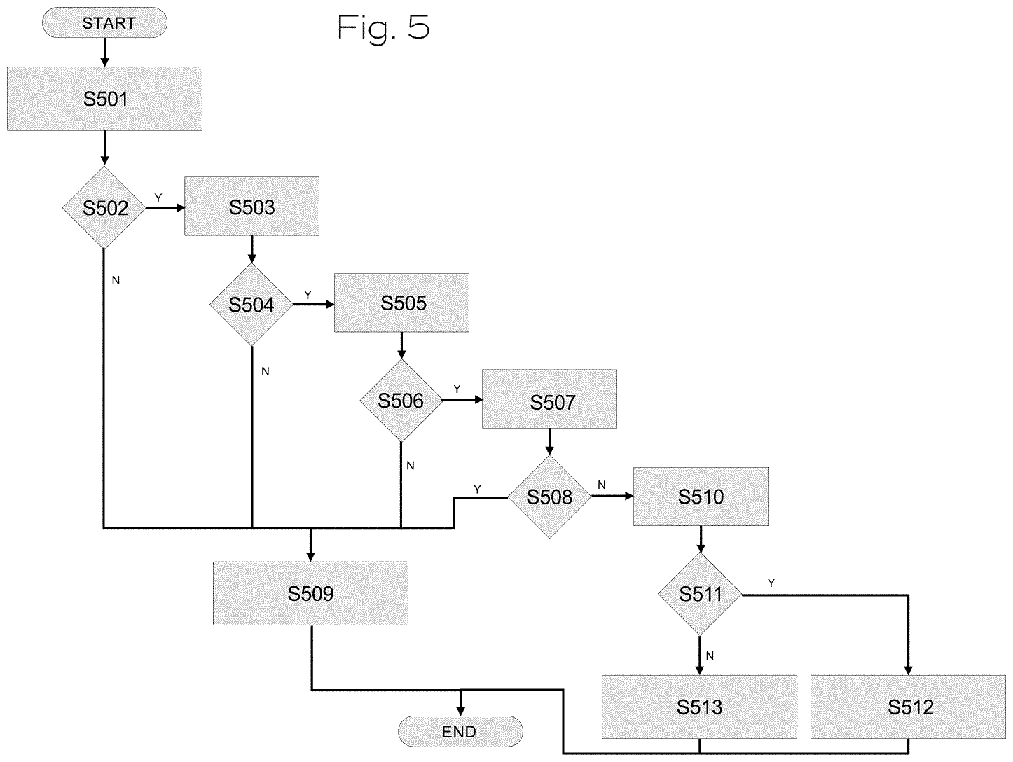

FIG. 5 shows a schematic flowchart for creating electronic messages to client computers in a sub-delivery area. In step S501, the server receives an order from a client computer. The server checks whether the client computer is within a sub-delivery area (step S502). If it is not, the server computer does not send a message (step S509) and the method ends. If the client computer is within a sub-delivery area, then the server computer checks whether electronic message sending has been approved for the client computers in that sub-delivery area (steps S503 and S504).

If the release has been granted, then the server computer checks whether a time period has been defined for it (steps S505 and S506). If the current time is within the released time period, then the server computer checks all client computers in the sub-delivery area to see if an order has already been placed (steps S507 and S508). If this is not the case, then the server computer further checks whether a preferred provider has been defined for the client computers (steps S510 and S511). If no preferred provider has been defined, then the server computer sends electronic messages to the client computers that an order time slot has been opened in the sub-delivery area (step S513). If, on the other hand, preferred providers have been defined, then the server computer points out the preferred providers in this sub-delivery area in the electronic messages (step S512).

The invention is not limited to the exemplary embodiments, but rather comprises all methods and devices in the context of the following patent claims.

### REFERENCES

1 Offer list
2 Server computer
3, 3′, 3″ Client computer
4 User database
5 Supplier database
6 Order time database
7, 7′, 7″ Supplier computer
8 Delivery area database
9 Delivery area
10, 10′ Sub-delivery area

What is claimed is:

1. A computer-implemented method for generating an electronic offer list (1) by a server computer (2) for transmission to a client computer (3, 3′, 3″), comprising the following steps, which are performed by the server computer (2):
a. receiving, from a client computer (3, 3′, 3″), a request for a product type,
b. determining, by querying a user database (4) or a delivery area database (8), a delivery area Lᵢ associated with the client computer (3, 3′, 3″) or its user,
c. determining, by querying a supplier database (5), at least one supplier Aⱼ of the product type for the delivery area Lᵢ,
d. compiling the determined suppliers Aⱼ in an electronic offer list (1),
e. transmitting the offer list (1) to the client computer (3, 3′, 3″),
f. receiving, from the client computer (3, 3′, 3″), an order for a product P from a supplier Aⱼ,
g. forwarding the order to the supplier Aⱼ,
wherein the method comprises the steps of:
h. providing an order time database (6), which can be updated by the server computer (2), for including order time slots Tⱼ for the reception of orders from the suppliers Aⱼ,
i. checking, by querying the order time database (6), whether open order time slots Tⱼ exist for the determined suppliers Aⱼ and, if necessary, including the order time slot Tⱼ in the offer list (1), and
j. when an order from a supplier Aⱼ is received for whom no order time slot Tⱼ yet exists in the order time database (6), creating an order time slot Tⱼ for this supplier Aⱼ.

2. The method according to claim 1, wherein those suppliers Aⱼ with open order time slots Tⱼ are ranked higher up in the offer list (1).

3. The method according to claim 1, wherein in the offer list (1) the suppliers Aⱼ are sorted depending on which order time slots Tⱼ end first.

4. The method according to claim 1, wherein separate order time slots Tⱼ for the delivery of products and order time slots Tⱼ′ for the pick-up of products are provided by the server computer (2).

5. The method according to claim 1, wherein the order time slots Tⱼ are each created for a time period Δt, wherein the time period Δt is supplier-specific and is determined by querying the supplier database (5).

6. The method according to claim 1, wherein a maximum number Kⱼ of orders is provided for the order time slots Tⱼ, wherein the number Kⱼ is supplier-specific and is determined by querying the supplier database (5), and wherein the server computer (2) checks whether the number of orders in existing order time slots Tⱼ permits the booking of a new order.

7. The method according to claim 1, wherein, when an order is received, the server computer (2) informs individual or all users listed in the user database (4) from the delivery area Lᵢ of the order by transmitting an electronic message and, if necessary, transmits to the client computers (3, 3′, 3″) of the users the order time slots Tⱼ open in this delivery area Lᵢ.

8. The method according to claim 7, wherein the server computer (2), upon receipt of an order within a delivery area Lᵢ, defines a sub-delivery area SLᵢ assigned to the ordering client computer, informs those client computers listed in the user database (4) which are located in the sub-delivery area SLᵢ, of the order by transmitting an electronic message, and transmits to these client computers any order time windows Tⱼ which are open in this sub-delivery area SLᵢ.

9. The method according to claim 1, wherein the server computer (2) receives the position data of the client computer (3, 3′, 3″), in particular GPS coordinates, for determining the delivery area Lᵢ and, if applicable, the sub-delivery area SLᵢ, and determines the corresponding address by querying an external address database, and determines the delivery area Lᵢ and, if applicable the sub-delivery area SLᵢ, by matching the address with delivery area addresses stored in advance in the delivery area database (8).

10. The method according to claim 1 further comprising creating and sending the electronic offer list (1) in a factory building with a plurality of physically distributed client computers and a plurality of physically distributed warehouses acting as suppliers of the required goods.

11. A computer-readable storage medium, comprising instructions which cause a server computer (2) to perform a method according to claim 1.

12. A device for generating an electronic offer list (1) by a server computer (2) for transmission to a client computer (3, 3′, 3″), comprising a server computer (2), wherein the server computer (2) is adapted:
a. to receive, from a client computer (3, 3′, 3″), a request for a product type,
b. to determine, by querying a user database (4) or a delivery area database (8), a delivery area Lᵢ associated with the client computer (3, 3′, 3″) or its user,
c. to determine, by querying a supplier database (5), at least one supplier Aⱼ of the desired product P for the delivery area Lᵢ,
d. to compile the determined suppliers Aⱼ of the product P in an electronic offer list (1),
e. to transmit the offer list (1) to the client computer (3, 3′, 3″),
f. to receive, from the client computer (3, 3′, 3″), an order for a product P from a supplier Aⱼ,
g. to forward the order to the supplier Aⱼ,
wherein the server computer (2) is adapted
h. to provide an order time database (6), which can be updated, for including order time slots Tⱼ for the reception of orders from the suppliers Aⱼ,
i. to check, by querying the order time database (6), whether open order time slots Tⱼ exist for the determined suppliers Aⱼ and, if necessary, to include the order time slots Tⱼ in the offer list (1), and
j. when an order from a supplier Aⱼ is received for whom no order time slot Tⱼ yet exists in the order time database (6), to create an order time slot Tⱼ for this supplier Aⱼ.
